(19) United States
(12) Patent Application Publication
(10) Pub. No.: US 2003/0196508 A1
(43) Pub. Date: Oct. 23, 2003

(54) Sound-proof geared cable

(75) Inventors: Kenji Uenaka, Takarazuka-shi (JP); Hirotaka Egawa, Takarazuka-shi (JP)

Correspondence Address: BROWDY AND NEIMARK, P.L.L.C., 624 NINTH STREET, NW, SUITE 300, WASHINGTON, DC, 20001-5303, US

(73) Assignee: Nippon Cable System Inc., Takarazuka-shi (JP)

(21) Appl. No.: 10/446,868

(22) Filed: May 29, 2003

Related U.S. Application Data
(63) Continuation of application No. 09/533,659, filed on Mar. 23, 2000.

(30) Foreign Application Priority Data
May 23, 1999 (JP) 78523/99

(51) Int. Cl. F16C 1/20

(52) U.S. Cl. 74/502.5

(57) ABSTRACT

A sound-proof geared or toothed cable A which comprises a core member 1 made of a twisted metal wires, teeth 2 consisting of at least one metal wire spirally wound around a peripheral surface of the core member 1, and a synthetic resin or rubber made tube 3 which is closely spirally wound between the teeth 2, and an outer surface of which protrudes externally of an outer surface of the teeth 2. An outer diameter of the tube 3 is 1.2 to 5 times an inner diameter of the tube 3 and a winding outer diameter of the tube 3 is 1.01 to 1.1 times a winding outer diameter of the teeth member 2.

### CROSS REFERENCE TO RELATED APPLICATION

The present application is a continuation of U.S. patent application Ser. No. 09/533,659, filed Mar. 23, 2000, the entire contents of which are hereby incorporated by reference.

### BACKGROUND OF THE INVENTION

1. Field of the Invention

The present invention relates to a sound-proof toothed cable or geared cable, more particularly, to a sound-proof geared cable which is to be housed in a conduit in a sliding manner, which is push-pull-driven by a gear or any other geared cable, and which is used for opening/closing an automobile sun-roof or the like.

2. Description of the Related Art

A prior art sound-proof geared cable comprises, as shown in FIG. 4, a core or core member 101 and a tooth strip or a teeth member (coil) 102 which is at least one metal strand spirally wound around the core at the same intervals to make teeth. The above-mentioned core 101 is formed by twisting metal strands, typically comprising a core wire (or center wire) 103 typically 20 made of a metal wire, a first winding layer 104 in which four to six metal wires are closely spirally wound around the periphery of the center wire 103, a second winding layer 105 in which four to six metal wires are closely spirally wound in an opposite direction around the periphery of the first winding layer 104, and a third winding layer 106.

A geared cable 107 thus constructed has flexibility and, when housed inside a conduit in a sliding manner, meshes with a gear or any other geared cable to be driven. The geared cable 107 is engaged with a driven member at its end or middle thereof, thus being used in remote operation of other various machines, for example, for opening/closing an automobile sun-roof or lifting/lowering a window glass of the automobile.

The above-mentioned conduit may come in a flexible one consisting of a metal spiral tube and a non-flexible one consisting of a simple metal tube, generally being used as curved between an operating side and a passive side of a geared cable. A teeth of the geared cable, therefore, slides with a metal inner surface of the conduit, thus raising noise. Particularly at a curved site of the conduit, the teeth slides with the inner surface of the conduit in an irregular manner, thus producing larger noise.

To suppress such noise, the Applicant has early proposed a sound-proof geared cable which comprises: a core made of metal; teeth member formed by winding at least one metal wire spirally around a peripheral surface of the core at the same intervals; and a hollow elastic or elastomeric body which is closely spirally wound between the teeth or loops of the tooth strip and whose outer surface protrudes externally of the outer surface of the teeth (see Laid-Open Utility Publication No. Sho-58-13169 or Japanese Utility model Publication No. 13169/1983). In this type of a cable, at its straight portion, the externally protruding elastic or elastomeric body slides with the inner surface of the conduit, thus suppressing noise. At its curved portion, moreover, the elastic or elastomeric body is largely displaced out of the teeth, thus further suppressing noise. At its portion where the teeth meshes with the gear, furthermore, by removing the hollow elastic or elastomeric body, the meshing is not disturbed.

Although the above-mentioned prior-art sound-proof geared cable has a sufficient sound-proof effects as well as high operability and durability, further improvement in sound-proof performance is desired to meet ever increasing driver's demands for silence within an automobile in recent years. The invention technologically aims at providing a sound-proof geared cable with further improved sound-proof performance without compromising advantages of the operability and durability of the above-mentioned prior-art sound-proof geared cable.

### SUMMARY OF THE INVENTION

A sound-proof geared cable of the present invention comprises a core, teeths formed by spirally winding at least one metal wire around a peripheral surface of the core at the same intervals, and a synthetic resin-made or rubber-made tube which is closely spirally wound between the teeth and whose outer surface protrudes externally of the outer surface of the teeth, in which an outer diameter of the above-mentioned tube is 1.2 to 5 times its inner diameter and a winding outer diameter of that tube is 1.01 to 1.1 times a winding outer diameter of the teeth. Preferably, the outer diameter of the tube is 1.0 to 1.05 times a wire diameter of the teeth. Also, preferably the gap between the adjacent teeth is 0.9 to 1 times the outer diameter of the tube.

With such a sound-proof geared cable, the above-mentioned core preferably is a twisted strands comprising a center wire or wires and at least one metal winding layer made by spirally winding strands around the center wire or wires. More preferably, the above-mentioned tube is an extruded product of thermoplastic resin or rubber material. Still more preferably, the above-mentioned tube is adhered to a surface of the core. Also preferably, the outer diameter of the sound-proof geared cable is 3 to 9 mm.

A method for manufacturing the sound-proof geared cable of the present invention comprises the steps of: spirally winding at least one metal wire around a peripheral surface of a core at the same intervals to form teeth; dropping an adhesive agent on the core; and closely spiral-winding between these teeth a synthetic-resin or rubber made tube having a larger diameter than the wire of teeth.

The geared cable of the present invention is housed in a conduit in a sliding manner and driven by a gear or other geared cable, thus transferring power to a driven member. In this configuration, an outer diameter of the tube is 1.2 times or more of its inner diameter, to provide a relatively large thickness, thus giving sufficiently strong resistance of the tube against the sliding resistance of the conduit and the sharing force of the core moving. Hence higher durability. At the same time, the outer diameter of the tube is not more than 5 times its inner diameter, thus enjoying proper elasticity and flexibility.

Also, since a winding diameter of the tube is 1.01 times or more of a winding diameter of the teeth, the outer surface of the tube protrudes sufficiently externally of the outer surface of the teeth. Therefore, sliding noise can be suppressed between the teeth and the conduit. Moreover, since the winding outer diameter of the tube is 1.1 times or less of the winding diameter of the teeth, the shearing force applied to the tube is securely supported by the teeth. With this, elastic deformation due to the shearing force applied on the tube is suppressed below a low level, thus improving durability of the tube.

With the geared cable having a gap between the adjacent teeth which is 0.9 to 1 times the outer diameter of the tube, the tube as spirally wound in the gap between these teeth is strongly engaged with the teeth while being elastically deformed vertically. Therefore, there is provided strong adherence between the tube and the teeth, thus preventing the tube from sliding on the center wire. Moreover, the shearing force of the tube can even securely supported by the teeth. Further, since the tube is elastically deformed vertically, the tube protrudes sufficiently externally of the outer surface of the teeth.

When the above-mentioned core is made of twisted metal strands having at least one metal winding layer provided on a center wire or strands, the core has high flexibility and also high tensile strength. When the above-mentioned tube is adhered to the core surface with an adhesive agent, the tube, even if subject to external force, is not shifted between the teeth nor largely deformed. Hence higher durability is obtained. If the outer diameter of the sound-proof geared cable is less than 3 mm, it has lower -strength and, if it is in excess of 9 mm, it is not easily bent, so that the outer diameter is preferably 3 to 9 mm.

A method for manufacturing geared cable according to the present invention enables efficiently make a geared cable according to the invention. Also, since the tube is adhered to the core with an adhesive agent, the tube, even when subject to external force, is not shifted between the teeth nor largely deformed. Hereinafter, some embodiments of a sound-proof geared cable of the present invention will be explained with reference to the attached drawings.

### BRIEF DESCRIPTION OF THE DRAWINGS

FIG. 1 is a side view of an important part showing a sound-proof geared cable according to one embodiment of the present invention.

FIG. 2 is a side view showing a service condition of the sound-proof geared cable.

FIG. 3 is a step drawing showing a method of manufacturing the sound-proof geared cable according to the embodiment of the invention.

FIG. 4 is a side view showing one example of a prior art sound-proof geared cable.

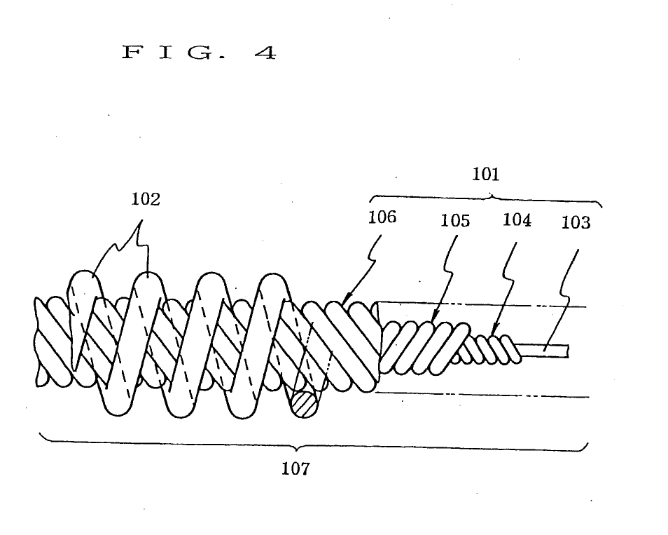

### DESCRIPTION OF THE PREFERRED EMBODIMENTS

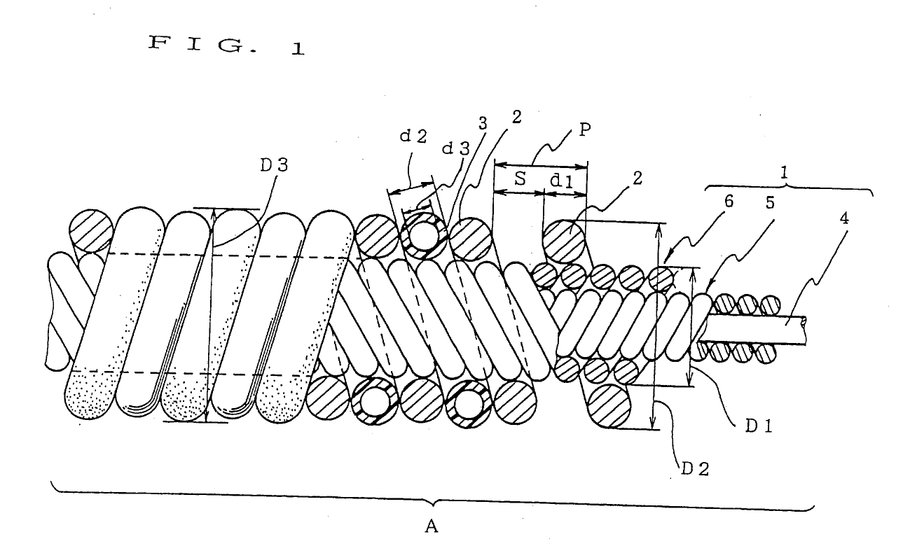

A geared cable A shown in FIG. 1 comprises a core 1 consisting of a metal wire, a teeth member or tooth strip 2 spirally wound at the same intervals (gap) S around the periphery of the core 1, and a synthetic resin-made tube 3 which is spirally wound and adhered between the adjacent teeth 2. The core 1 consists of a twisted metal wire which comprises a center wire 4 made of a metal wire, a first winding layer 5 consisting of 3 to 8 metal strands spirally wound around the periphery of the center wire 4, and a second winding layer 6 consisting of 3 to 8 metal strands spirally wound around in an opposite direction around the periphery of the first winding layer 5. The winding layer may be provided as many as three or more. The center wire 4 may consists of a hard-steel wire, a piano wire, or a spring-steel wire having a diameter of 0.4 to 1 mm. The metal wire constituting the first winding layer 5 may be spring-steel wire having almost the same diameter as the center wire 4 or a little smaller, e.g. 0.3 to 0.8 mm. The metal wire constituting the second winding layer 6, in particular, may be hard-steel wire, piano wire, or spring-steel wire having almost the same diameter as the center wire 4. The metal strands of each of the winding layers 5 and 6 are typically spirally wound with no gap therebetween. The outer diameter of the core 1, i.e. the winding diameter D1 of the second winding layer 6 is for example 1.5 to 4.5 mm.

The above-mentioned teeth 2 may be metal wire or wires, in particular, hard-steel wire, piano wire, or spring wire having a diameter d1 which is 0.3 to 0.8 times the outer diameter D1 of the core 1, e.g., 0.4 to 1. 5 mm. A pitch P between the teeth is of such a value that may leave a gap S, e.g. 2 to 3 mm, between the teeth 2 which is somewhat smaller than an outer diameter d2 of the tube 3 as left in a natural state. The gap S in such a case is about 0.9 to 1, preferably 0.92 to 0.96 times the outer diameter of the tube S. By providing such a gap S sized smaller than the outer diameter of the tube 3, the tube 3 as wound between the teeth 2 may be elastically deformed somewhat vertically, thus butting strongly against the teeth in a significant area therebetween. With this, sliding resistance applied between the tube 3 and the conduit is securely supported by the teeth 2. The winding outer diameter D2 of the teeth is 1.2 to 2.5 times, preferably 1.4 to 2.0 times in particular the outer diameter D1 of the core 1. Since the teeth 2 is wound tightly onto the core 1, the winding outer diameter D2 is usually about 0.1 to 1.0 mm smaller than a value obtained by adding twice the diameter of the teeth 2 to the diameter D1 of the core 1.

The above-mentioned tube 3 may be an extruded product of a thermoplastic resins such as nylon, polyurethane, polyester-based or polyolefin-based thermoplastic resin, and the like or those elastomer, or rubbers such as silicon rubber, ethylene-propylene rubber, and the like. Its hardness, when thermoplastic resin or its elastomer is employed, is preferably D30 to 80, especially D40 to 60 approximately as Shore hardness and, for rubber, A60 to 90 approximately, more preferably A70 to 90 approximately. The outer diameter d2 of the tube 3 is preferably almost the same as the diameter of the teeth 2 or larger, preferably 1 to 1.05 times that. Even if it is less than that, by making the gaps between the loop of the tooth-strip sufficiently small, the tube 3 accordingly deformed elastically can protrude externally of the outer surface of the teeth 2. However, if the tube 3 deforms too much, its strain cannot be sufficiently eliminated by thermal treatment. It is, therefore, preferably not less than that diameter. If it is more than 1.05 times that, on the other hand, strong shearing force is applied between the teeth 2 and the tube 3 subject to sliding resistance of the conduit, so that its durability is liable to be deteriorated.

Also, the outer diameter d2 of the tube 3 is 1.2 to 5, preferably 1.5 to 3 times its inner diameter. If it is less than 1.2 times that, the tube thickness is too small, thus deteriorating the durability if the tube is subject to strong sliding resistance. If it is more than 5 times that, the tube 3 is not easily deformed elastic or elastomerically, thus increasing a minimum curving radius of the geared cable. Also, since the gap S between the teeth 2 is smaller than the outer diameter of the tube 3, the tube when wound in that gap is somewhat deformed vertically in terms of its cross-sectional shape. With this, the winding outer diameter D2 of the tube 3 becomes about 1.01 to 1.1 times the winding outer diameter D3 of the wire of the teeth 2. The outer surface of the tube 3, therefore, protrudes from that of the teeth 2 by about 0.03 to 0.9 mm, for example.

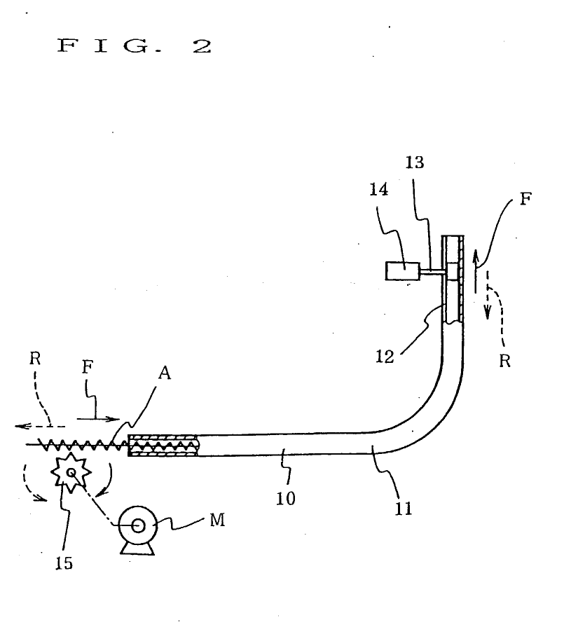

Thus constituted geared cable A has flexibility, thereby transferring push/pull, i.e. bi-directional force. This geared cable A is used in a conduit 10 as inserted therein as shown in FIG. 2 for example. As the conduit 10, a conventional known one may be used. On the surface of the geared cable A is applied beforehand grease or any other lubricant. The conduit 10 has a curve 11 and partially a slit 12. Through the slit 12 penetrates a coupling member 13 fixed to the geared cable in its middle, to which member is attached a driven member 14. Moreover, the geared cable A meshes with a gear 15 driven by a motor M.

When the motor M rotates in one direction, the gear 15 rotates in a direction of a solid-line arrow, pushing the geared cable A in a direction indicated by an arrow F. With this, the geared cable A slides within the conduit 10 in the direction of the arrow F. Via the coupling member 13, therefore, the driven member 14 is driven. The conduit 10 has the curve 11 but the geared cable A has flexibility, so that it can travel along an axis, changing its direction as influenced by reaction force from the conduit 10 at the curve 11. When the gear 15 is rotated in a direction indicated by a broken-line arrow, the geared cable A retracts in a direction indicated by an arrow R. With this, the driven member 14 can be push/pull-manipulated.

The geared cable A now present in the conduit 10 does not directly or not strongly come in sliding contact with the inner surface of the conduit 10 during the above-mentioned travel, because as shown in FIG. 1 the outer surface of the tube 3 protrudes beyond the outer surface of the teeth 2. Noise is thus suppressed. Also, since the gap between the teeth 2 becomes smaller at around the inner side of the radius of the curve 11, the tube 3 protrudes further externally around that potion. Therefore, noise-preventing effects are even more enjoyed at the geared cable A and at around the inner side of the curve.

Also since in the case of the geared cable A, the outer diameter d2 of the tube 3 is generally larger than the gap S between the teeth 2, the tube 3 is strongly engaged between the teeth. Therefore, force (shearing force) applied onto the tube 3 in an axial direction of the cable is sufficiently supported by the teeth 2, so that the tube 3 is not easily delaminated from the core 1 at its part adhered thereto, thus improving the durability.

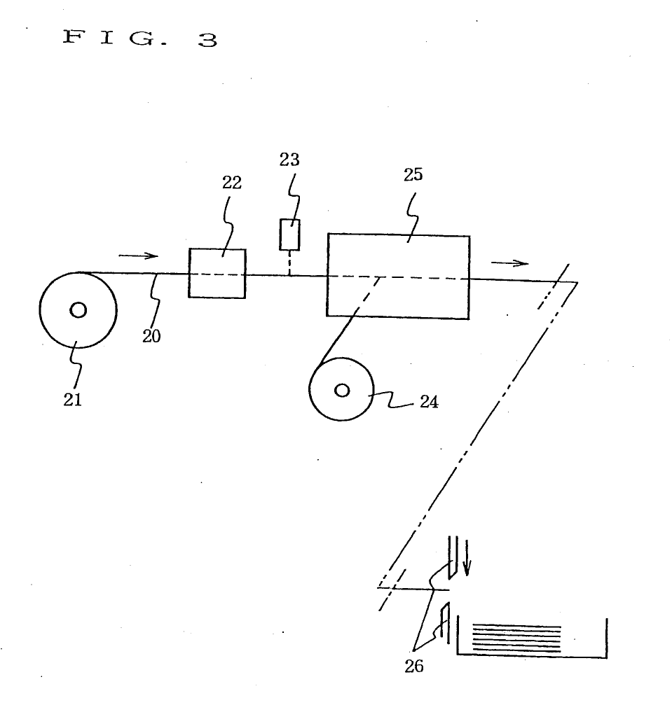

The following will describe a method for manufacturing the above-mentioned geared cable A according to embodiment of the invention with respect to FIG. 3. The core 1 and the wire for the teeth 2 are beforehand manufactured with the same method as a conventional one and the wire for the teeth 2 is spirally wound with a winder etc. around the periphery of the core 1 at a predetermined pitch, to provide a tube-less geared cable 20, which is then wound up on a drum. The tube 3 is also manufactured beforehand by extrusion with a predetermined size and wound up on a drum.

As shown in FIG. 3, first the above-mentioned tube-less geared cable 20 is unwound from the drum 21, to concurrently check a pitch of the teeth 2 with a pitch meter 22. Then, an adhesive agent is dropped onto the core 1 and the teeth 2 with an adhesive-agent supplier 23. The adhesive agent is selected from a -cyano-acrylate-based and hot-melting type ones. The tube 3 is supplied to a winder 25 as being unwound from the drum 24 and, immediately after the adhesive agent is dropped, is wound up between the teeth 2 using the winder 25. In this case, the tube 3 is strongly engaged between the teeth 2 as applying a predetermined range of tension to the tube 3. Note here that the tube 3, when unwound from the drum 24, is somewhat twisted, which twisting should preferably be reduced as much as possible.

Even if the tube 3 is twisted when it is wound, the corresponding elastic stress is relaxed. Then, it is cut to a predetermined length with a cutter 26.

The above-mentioned manufacturing method makes it possible to consecutively and efficiently manufacture the above-mentioned geared cable A.

Although in the above-mentioned embodiment, the core 1 has two layers of windings provided around the center wire 4, the number of the layers may be three or larger or even one. The number and the diameter of the metal strands of the winding layer may be other than those specified in this embodiment.

### EXAMPLES

The following will describe the operational effects of a sound-proof geared cable of the present invention with reference to examples and comparative examples.

### Example 1

Referring to FIG. 1, the Applicant spirally wound four hard-steel wires with an outer diameter of 0.36 mm around a periphery of one center wire 4 consisting of a hard-steel wire with an outer diameter of 0.73 mm to form a first winding layer 5 and spirally wound six hard-steel wires with an outer diameter of 0.6 mm. in an opposite direction to form a second winding layer 6, thus manufacturing a core 1. Then, the Applicant spirally wound a hard-steel wire with an outer diameter of 1.2 mm an such a manner so as to provide a gap of 0.94 mm, thus forming teeth 2. Next, the Applicant dropped an adhesive agent on it and then wound into the gap between the teeth a nylon tube with an outer diameter of 1.35 and an outer diameter/inner diameter ratio of 1.35, thus obtaining a sound-proof geared cable A of Example 1. The ratio (D3/D2) between the winding outer diameter D3 of the tube and the winding diameter D2 of the teeth was 1.05.

This sound-proof toothed tube A was, in a condition as shown in FIG. 2, inserted in a pipe with an inner diameter of 5.6 to 6.6 mm and an outer diameter of 7 to 8 mm, to measure a noise level under the conditions of a speed of 20 mm/s and a load of 6 kgf. Also, the sound-proof geared cable was reciprocated 10,00 times, to test its durability and confirm the state after duration. Note here that grease was applied to the inside of the pipe. The results of the durability test are shown in the column of “Performance” in Table 1.

### Examples 2 to 4

The Applicant spirally wound two tubes with an outer diameter/inner diameter ratio of 4.9 and 1.2 respectively onto a geared cable having the same construction as that of Example 1 in a manner similar to Example 1, thus manufacturing a sound-proof geared cables of Examples 2 and 3 respectively. Also, the Applicant spirally wound a tube with an outer diameter/inner diameter ratio of 1.35 in such a manner as to provide a ratio between the tube winding outer diameter and the teeth winding outer diameter of 1.1 and otherwise did the same way, thus manufacturing a sound-proof geared cable of Example 4. The Applicant conducted the durability test 10,000 times on the Examples 2 to 4 under the same conditions as the above-mentioned Example .1. The results are shown in Table 1 below.

TABLE 1

| Item | Example 1 | Example 2 | Example 3 | Example 4 |
|---|---|---|---|---|
| 1 Configuration | | | | |
| Tube outer diameter | 1.35 | 4.9 | 1.2 | 1.35 |
| (ratio against inner | | | | |
| diameter) d2/d3 | | | | |
| Tube winding | 1.05 | 1.05 | 1.05 | 1.1 |
| outer diameter | | | | |
| (ratio against teeth outer | | | | |
| diameter) D3/D2 | | | | |
| Inter-teeth gap S | 0.94 | 0.94 | 0.94 | 0.94 |
| Core construction | Winding | Winding | Winding | Winding |
| Adhesion | Provided | Provided | Provide | Provided |
| Outer diameter (mm) | 5.0 | 5.0 | 5.0 | 5.0 |
| 2 Performance | | | | |
| Sounding dB | 41 | 40 | 42 | 40 |
| Durability | No | No | No | No |
| (State after performing | abnormal | abnormal | abnormal | abnormal |
| durability 10,000 times | | | | |
| test) | | | | |
| \mathring{3} Judgment | ⊚ | ⊚ | ⊚ | ⊚ |

### Comparative Examples 1 to 4

The Applicant manufactured a sound-proof geared cable under the same conditions as Example 1 except that the tube outer diameter was 1.1 times its inner diameter, as Comparative Example 1. The Applicant also manufactured another sound-proof geared cable as Comparative Example 2 under the same conditions as Example 1 except that the ratio between the tube winding outer diameter and the teeth winding outer diameter was 1. The Applicant also manufactured two sound-proof geared cables as Comparative Examples 3 and 4 as using no adhesive agent and having a inter-teeth gap of 1.2 mm respectively. The Applicant conducted the same durability test as the examples on the sound-proof geared cables of Comparative Examples 1 to 4. Measurements of the noise level are shown in Table 2 below.

TABLE 2

| | Com. | Com. | Com. | Com. |
|---|---|---|---|---|
| Item | Example 1 | Example 2 | Example 3 | Example 4 |
| 1 Configuration | | | | |
| Tube outer diameter | 1.1 | 1.35 | 1.35 | 1.35 |
| (ratio against inner | | | | |
| diameter) d2/d3 | | | | |
| Tube winding | 1.05 | 1 | 1.05 | 1.05 |
| outer diameter | | | | |
| (ratio against teeth outer | | | | |
| diameter) D3/D2 | | | | |
| Inter-teeth gap S | 0.94 | 0.94 | 0.94 | 1.2 |
| Core construction | Winding | Winding | Winding | Winding |
| Adhesion | Provided | Provided | Not pro. | Provided |
| Outer diameter (mm) | 5.0 | 5.0 | 5.0 | 5.0 |
| 2 Performance | | | | |
| Sounding dB | 46 | 51 | 42 | 43 |
| Durability | Tube | Pipe | Tube | Tube |
| (State after performing | peel-off | wear | peel-off | peel-off |
| durability 10,000 times | | ovserved | | |
| test) | | | | |
| \mathring{3} Judgment | x | x | Δ | Δ |

As can be seen from the above results, 5 Examples 1 to 4 came up with a low noise level of 40 to 42 dB with no tube peel-off nor pipe wear observed. The sound-proof geared cables of comparative Examples 1 and 2, however, came up with a high noise level of 46 dB and 51 dB respectively, even with tube peel-off and wear at the inner surface of the pipe. Also, Comparative Examples 3 and 4 came up with tube peel-off. From the above, the sound-proof geared cables according to the invention has predetermined noise-preventing effects even with sufficient durability.

What is claimed is:

1. A sound-proof geared cable comprising a core;
a. teeth consisting of at least one metal wire spirally wound around a peripheral surface of said core at equal intervals; and
b. a synthetic resin or rubber tube which is closely spirally wound between said teeth and an outer surface of which protrudes externally of an outer surface of said teeth;
c. wherein said core consists of a twisted metal wire which comprises a center wire made of a metal wire, a first winding layer consisting of 3 to 8 metal strands spirally wound around the periphery of the center wire, and a second winding layer consisting of 3 to 8 metal strands spirally wound in an opposite direction around the periphery of the first winding layer;
d. an outer diameter of said tube is 1.2 to 5 times an inner diameter of said tube; and
e. a winding outer diameter of said tube is 1.10 to 1.1 times a winding outer diameter of said teeth;
f. wherein the hardness of the tube is D30 to D80 hardness when the tube is made of thermoplastic resin or elastomer, or A60 to A90 hardness when the tube is made or rubber;
g. said tube is adhered to a surface of said core; and
h. a gap between adjacent teeth is 0.9 to 1 times the outer diameter of the tube.

2. The sound-proof geared cable according to claim 1 wherein said tube is an extruded product of thermoplastic resin or rubber.

3. The sound-proof geared cable according to claim 1 wherein said tube is an extruded product of a material selected from the group consisting of nylon, polyurethane, polyester-based and polyolefin-based thermoplastic resins, elastomers of said thermoplastic resins, silicone rubber, and ethylene-propylene rubber.

4. The sound-proof geared cable according to claim 1 wherein said winding outer diameter of said tube is 3 to 9 mm.

5. The wound-proof geared cable according to claim 2 wherein said winding outer diameter of said tube is 3 to 9 mm.
